(19) United States
(12) Patent Application Publication
(10) Pub. No.: US 2019/0358811 A1
(43) Pub. Date: Nov. 28, 2019

(54) Control Apparatus And Robot System

(71) Applicant: Seiko Epson Corporation, Tokyo (JP)

(72) Inventors: Daisuke SATO, Matsumoto (JP); Yukihiro UNNO, Matsumoto (JP)

(21) Appl. No.: 16/417,724

(22) Filed: May 21, 2019

(30) Foreign Application Priority Data
May 22, 2018 (JP) 2018-097625

(51) Int. Cl. B25J 9/16; B25J 9/00; B25J 9/02; B25J 13/08

(52) U.S. Cl. CPC B25J 9/1633; B25J 9/0081; B25J 13/085; B25J 9/161; B25J 9/163; B25J 9/02

(57) ABSTRACT

A control apparatus includes a processor that is configured to control a robot including an arm and a force detector detecting a force applied to the arm, wherein the processor is configured to control the arm in a first control mode in which the arm is moved in a first direction when a direction of a force detected by the force detector is the first direction and a second control mode in which the arm is moved in a second direction different from the first direction when the direction of the force detected by the force detector is the first direction in teaching of the robot, and select the first control mode or the second control mode according to input by a user.

The present application is based on and claims priority from JP Application Serial Number 2018-097625, filed May 22, 2018, the disclosure of which is hereby incorporated by reference herein in its entirety.

### BACKGROUND

### 1. Technical Field

The present disclosure relates to a control apparatus of a robot and a robot system.

### 2. Related Art

As a mode for facilitating teaching work by a robot, a direct teaching mode in which a teacher directly holds fingers of a robot and operating the finger positions of the robot is known. In the direct teaching mode, the robot can be continuously and largely moved, however, fine positioning is difficult only by the continuous movement. In JP-A-2017-164876 disclosed by the applicant of the present application, a technique of fine positioning using a mode in which the robot is moved according to an external force in a predetermined direction and a predetermined amount is described.

JP-A-2017-164876 is an example of the related art.

However, in the above described related art, there is a problem that the direction in which the robot is moved is largely constrained because the external force applied to the robot and the movement direction of the robot according to the force are determined in advance.

### SUMMARY

According to an aspect of the present disclosure, a control apparatus that controls a robot including an arm and a force detector detecting a force applied to the arm is provided. The control apparatus includes a control unit that controls the arm in a first control mode in which the arm is moved in a first direction when a direction of a force detected by the force detector is the first direction and a second control mode in which the arm is moved in a second direction different from the first direction when the direction of the force detected by the force detector is the first direction in teaching of the robot. The control unit selects the first control mode or the second control mode according to input by a user.

### BRIEF DESCRIPTION OF THE DRAWINGS

FIG. 1 is a perspective view of an example of a robot system.

FIG. 2 is a conceptual diagram showing an example of a control apparatus having a plurality of processors.

FIG. 3 is a conceptual diagram showing another example of a control apparatus having a plurality of processors.

FIG. 4 is a functional block diagram of a robot and the control apparatus.

FIG. 5 is an explanatory diagram showing a relationship between a first direction and a second direction in a second control mode of a first embodiment.

FIG. 6 is a graph showing an example of changes of forces in the first embodiment.

FIG. 7 is a flowchart of teaching processing in the first embodiment.

FIG. 8 is a graph showing an example of changes of forces in a second embodiment.

FIG. 9 is an explanatory diagram showing an example of an input window in the second embodiment.

FIG. 10 is an explanatory diagram showing a relationship between a force and an amount of movement in a first control mode of a third embodiment.

FIG. 11 is a graph showing an example of changes of forces in the third embodiment.

### DESCRIPTION OF EXEMPLARY EMBODIMENTS

### A. First Embodiment

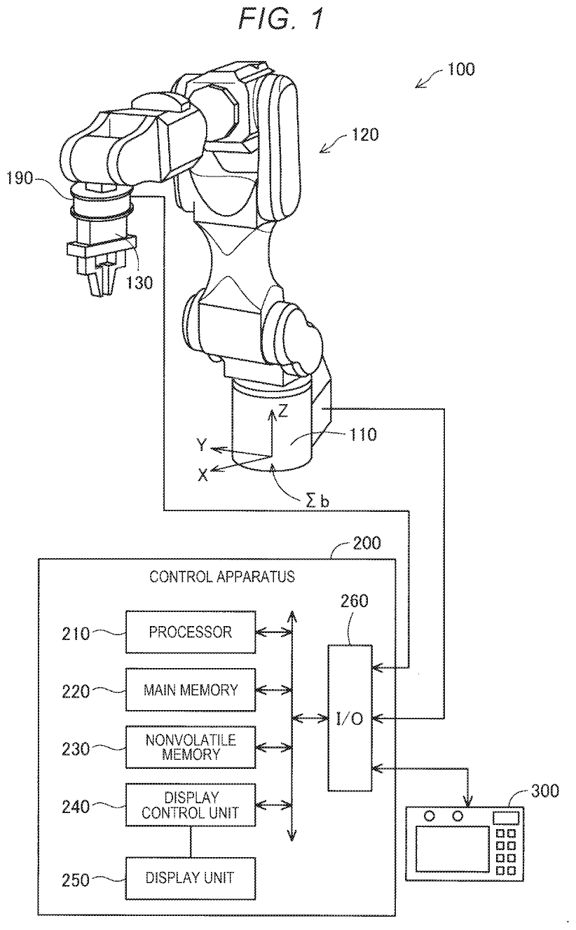

FIG. 1 is the perspective view showing the example of the robot system. The robot system includes a robot 100, a control apparatus 200, and a teaching apparatus 300. The control apparatus 200 is communicably connected to the robot 100 and the teaching apparatus 300 via cables or wireless connection.

The robot 100 has a base 110 and an arm 120. A force detector 190 is provided in the distal end of the arm 120, and an end effector 130 is attached to the distal end side of the force detector 190. In the example of FIG. 1, the end effector 130 is a gripper that grips an object, but an arbitrary type of end effector can be used. The arm 120 includes a plurality of joints. The position near the distal end of the arm 120 can be set as a tool center point (TCP). The TCP is a position used as a reference of the position of the end effector 130, and can be set in an arbitrary position. In this specification, the arm 120 and the end effector 130 are collectively referred to as “arm”.

A sensor coordinate system Σf is set for the force detector 190. A base coordinate system Σb is set for the base 110. The sensor coordinate system Σf is a kind of first coordinate system that moves according to the movement of the arm. As another first coordinate system, there is a tool coordinate system set for the end effector 130 or the like. The base coordinate system Σb is a kind of second coordinate system that does not move according to the movement of the arm. As another second coordinate system, there is a world coordinate system or the like.

The control apparatus 200 has a processor 210, a main memory 220, a nonvolatile memory 230, a display control unit 240, a display 250, and an I/O interface 260. These respective parts are connected via a bus. The processor 210 is e.g. a microprocessor or processor circuit. The control apparatus 200 is connected to the robot 100 and the teaching apparatus 300 via the I/O interface 260. Note that the control apparatus 200 may be housed inside of the robot 100. Or, the display 250 may be omitted from the control apparatus 200. In this case, a display formed separately from the control apparatus 200 may be used.

Note that, as the configuration of the control apparatus 200, various other configurations than the configuration shown in FIG. 1 can be employed. For example, the processor 210 and the main memory 220 may be removed from the control apparatus 200 in FIG. 1 and the processor 210 and the main memory 220 may be provided in another apparatus communicably connected to the control apparatus 200. In this case, the entire apparatus including the other apparatus and the control apparatus 200 functions as the control apparatus of the robot 100. In another embodiment, the control apparatus 200 may have two or more processors 210. In yet another embodiment, the control apparatus 200 may be realized by a plurality of apparatuses communicably connected to one another. In these various embodiments, the control apparatus 200 is configured as an apparatus or apparatus group including one or more processors 210.

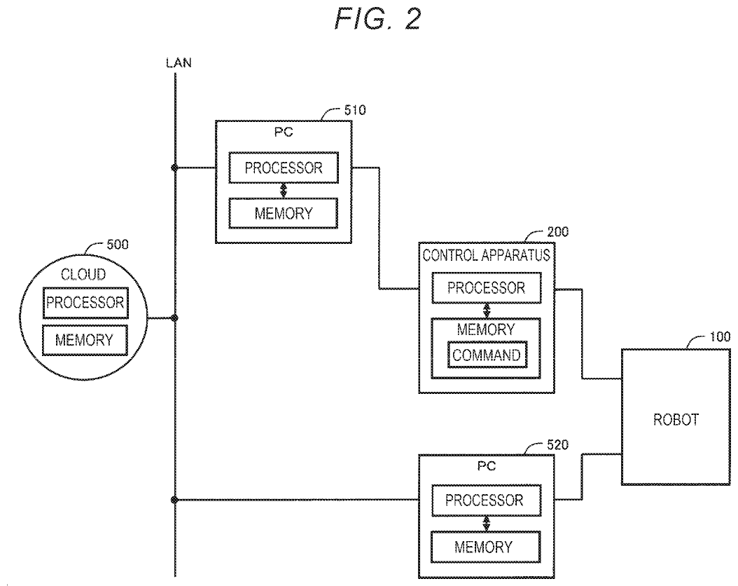

FIG. 2 is the conceptual diagram showing the example in which the control apparatus of the robot includes the plurality of processors. In this example, in addition to the robot 100 and the control apparatus 200, personal computers 510, 520 and a cloud service 500 provided via a network environment such as LAN are illustrated. Each of the personal computers 510, 520 includes a processor and a memory. Further, a processor and a memory are available in the cloud service 500. The control apparatus of the robot 100 can be realized using part or all of these plurality of processors.

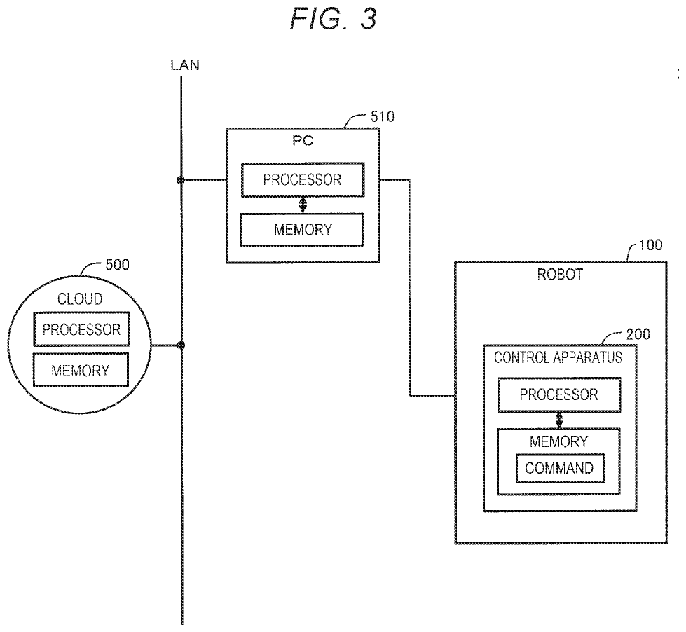

FIG. 3 is the conceptual diagram showing another example of the control apparatus of the robot including a plurality of processors. This example is different from that in FIG. 2 in that the control apparatus 200 of the robot 100 is housed in the robot 100. Also, in this example, the control apparatus of the robot 100 can be realized using part or all of the plurality of processors.

The force detector 190 is a six-axis force sensor that measures external forces applied to the end effector 130. The force detector 190 has three detection axes X, Y, Z orthogonal to one another in the sensor coordinate system Σf as an intrinsic coordinate system, and detects magnitude of forces parallel to the respective detection axes and magnitude of torque (moment of forces) about the respective detection axes. The forces parallel to the respective detection axes are referred to as “translational forces”. Further, the torque about the respective detection axes is referred to as “rotational forces”. In this specification, the word “force” is used in a meaning including both the translational force and the rotational force.

The force detector 190 is not necessarily a sensor that detects forces along the six axes, but a sensor that detects forces in the smaller number of directions may be used. Or, the force detector 190 is not necessarily provided in the distal end of the arm 120, but a force sensor as a force detector may be provided in one or more joints of the arm 120. Note that it is only necessary that “force detector” has a function of detecting a force. That is, “force detector” may be a device that directly detects a force like a force sensor or a device that indirectly obtains a force such as an IMU (Inertial Measurement Unit) or a device that detects a force from a current value of an actuator of the arm 120. Further, “force detector” may be provided outside or inside of the robot 100.

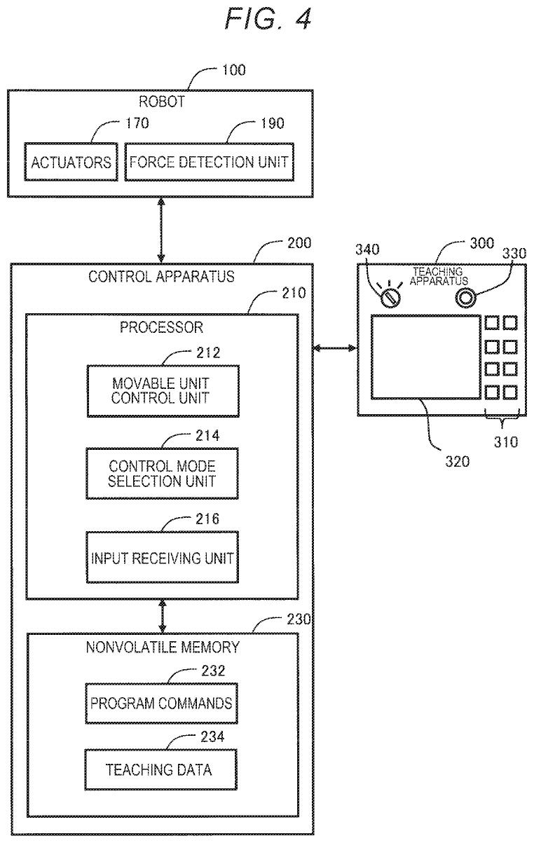

FIG. 4 is the block diagram showing the functions of the robot 100 and the control apparatus 200. The robot 100 has a plurality of actuators 170 for driving the plurality of joints in addition to the above described force detector 190. The processor 210 of the control apparatus 200 executes a program command 232 stored in the nonvolatile memory 230 in advance, and thereby, realizes functions of an arm control unit 212, a control mode selection unit 214, and an input receiving unit 216. The arm control unit 212 controls the actuators 170 to move the arm 120. The control mode selection unit 214 selects a first control mode or a second control mode, which will be described later, according to the input by a user. The control of the arm 120 in the first control mode and the second control mode is executed by the arm control unit 212. The processor 210 executing the functions of the arm control unit 212 and the control mode selection unit 214 corresponds to “control unit”. Teaching data 234 created by teaching processing is stored in the nonvolatile memory 230. Note that part or all of the functions of the arm control unit 212, the control mode selection unit 214, and the input receiving unit 216 may be realized using a hardware circuit.

The teaching apparatus 300 is used when a control program (teaching data) for work by the robot 100 is created. The teaching apparatus 300 is also called “teaching pendant”. The teaching apparatus 300 has a plurality of input buttons 310, a touch panel 320 that functions as an input device and a display device, an emergency stop button 330, and a switch with key 340. A teacher can provide various instructions and settings using the input buttons 310 and the touch panel 320. The switch with key 340 is used for selection of the control mode of the robot 100 from a plurality of control modes. The plurality of control modes include a playback mode, a normal teaching mode, a direct teaching mode, etc. Note that, in place of the teaching pendant, a personal computer with application programs for teaching processing installed therein can be used. For the teaching processing, the control apparatus 200 and the teaching apparatus 300 function as “control apparatus”. Note that teaching processing may be performed not using the teaching apparatus 300, but using the control apparatus 200 only.

In the teaching processing, the plurality of control modes including the first control mode and the second control mode to be described later are available.

### First Control Mode

The first control mode is a mode in which the arm is moved in a first direction when the direction of the force detected by the force detector 190 is the first direction. In the first embodiment, as the first control mode, a direct teaching mode in which the arm 120 is continuously moved according to the force detected by the force detector 190 is used. In the direct teaching mode, when the user applies a force while holding the end effector 130, the arm 120 smoothly moves according to the force. In this regard, the control apparatus 200 executes compliance control as a kind of force control to move the arm 120. The movement by the direct teaching mode is also referred to as “continuous movement”.

### Second Control Mode

The second control mode is a mode in which the arm is moved in a second direction different from the first direction when the direction of the force detected by the force detector 190 is the first direction. In the first embodiment, as the second control mode, a mode in which the arm 120 is moved in a predetermined amount of movement according to the force detected by the force detector 190 is used.

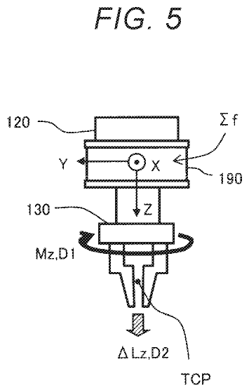

FIG. 5 is the explanatory diagram showing the relationship between the first direction and the second direction in the second control mode of the first embodiment. In this example, when the user pivots the end effector 130 along a first direction D1 as a pivot direction about the Z-axis, the arm moves in a second direction D2 parallel to the Z-axis direction in a predetermined amount of movement ΔLz according to the pivot. The second direction D2 is set, for example, on the assumption of a right-handed screw pointing in the Z-axis direction, to a direction in which the right-handed screw moves when the right-handed screw is turned along the first direction D1 as the pivot direction about the Z-axis. In the setting, there is an advantage that the operation is easy because the relationship between the first direction D1 and the second direction D2 is easily understood by the user. The amount of movement ΔLz in the second control mode is set to a small value e.g. from 0.1 mm to 1 mm. Therefore, in the second control mode, fine adjustment of the positions of the end effector 130 and the TCP can be made. The movement by the second control mode is also referred to as “fixed-amount movement”.

The second control mode is particularly useful in the following situation. That is, when the distal end of the end effector 130 is in a position sufficiently close to another object, fine adjustment to further move the end effector 130 in the Z-axis direction to be closer to the other object may be extremely difficult. In this case, the second control mode shown in FIG. 5 is used, and thereby, the end effector 130 can be easily moved in the Z-axis direction in the small amount of movement ΔLz. Particularly, in the second control mode, the direction D1 of a force Mz and the direction D2 of the amount of movement ΔLz are different, and thus, a possibility of a collision of the distal end of the end effector 130 with the other object can be decreased by the fine adjustment compared to the first control mode in which the direction of force and the direction of movement are the same.

In the example of FIG. 5, the distal end part of the arm 120 corresponds to “pivot part” and the pivot axis of the distal end part of the arm 120 corresponds to “pivot axis”. Note that these “pivot part” and “pivot axis” are examples and other parts of the arm may be referred to as “pivot part” and “pivot axis”.

Further, in the example of FIG. 5, the first direction is set to the pivot direction of the pivot axis and the second direction is set to the axial direction of the pivot axis, however, the first direction may be set to the translation direction and the second direction may be set to the pivot direction or rotation direction instead. For example, when a force is applied in the translation direction, the force can be applied with only one finger. On the other hand, when a force is applied in the rotation direction, the force is difficult to be applied with only one finger and twisting using two or more fingers is realistic. That is, a space is necessary for application of a force in the rotation direction. Therefore, the case where the first direction is set to the translation direction and the second direction is set to the pivot direction or rotation direction is advantageous in view of the space for force application.

In the first embodiment, one of the first control mode and the second control mode is selected according to the user's input. It is preferable that the display control unit 240 displays whether the first control mode or the second control mode is selected on one or both of the display 250 of the control apparatus 200 and the touch panel 320 of the teaching apparatus 300. Note that the user of the robot 100 in the teaching processing is also referred to as “teacher”.

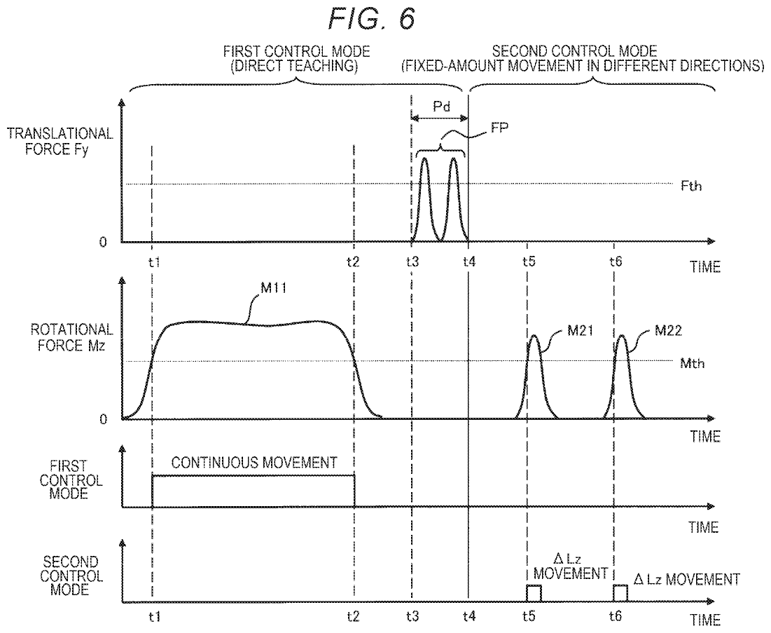

FIG. 6 is the graph showing the example of changes of forces detected by the force detector 190. In this example, a translational force Fy in the Y-axis direction, a rotational force Mz about the Z-axis, and movements by the first control mode and the second control mode are exemplified. The first control mode is set in a period until time t4, and the mode is switched from the first control mode to the second control mode at time t4.

In a period from time t1 to time t2, a rotational force M11 equal to or larger than a force threshold value Mth is detected. When the rotational force M11 is detected, continuous movement of the end effector 130 is executed along the direction of the rotational force M11. The rotational force M11 is the force about the Z-axis, and thus, the end effector 130 rotates about the Z-axis. Though not illustrated in FIG. 6, when a translational force is detected in the first control mode, the end effector 130 moves in the direction of the translational force. Therefore, the end effector 130 smoothly moves in a direction in which the user applies a force while being gripped by the user.

From time t3 to time t4, a force change pattern FP in which a pulsed translational force having a peak equal to or larger than a force threshold value Fth appears twice is detected within a predetermined time Pd. The force change pattern FP is detected by the user slightly tapping the end effector 130 twice, for example. The control mode selection unit 214 checks whether or not the force change pattern FP matches a predetermined reference pattern and, if the patterns match, the mode is switched between the first control mode and the second control mode. In the example of FIG. 6, a determination that the force change pattern FP matches the predetermined reference pattern is made, and the mode is switched from the first control mode to the second control mode at time t4. Note that “reference pattern” for switching between the control modes can be set to another arbitrary force change pattern than that in the example shown in FIG. 6.

In a period in the second control mode after time t4, at times t5, t6, two pulsed rotational forces M21, M22 having peaks equal to or larger than the force threshold value Mth are detected. When the rotational forces M21, M22 are detected, the end effector 130 respectively moves along the Z-axis direction in the predetermined amounts of movement ΔLz. Note that, when the movement in the small amount of movement ΔLz is executed in the second control mode, it is preferable not to move the end effector 130 or the TCP in the X-axis direction or Y-axis direction as another direction.

Though not illustrated in FIG. 6, in the period of the second control mode, when the same force change pattern as the force change pattern FP detected in the period from time t3 to time t4 is detected, switching from the second control mode to the first control mode is executed.

Note that the force threshold value Fth for the translational force is set in e.g. a range from 0.5 N to 10 N. Further, the force threshold value Mth for the rotational force is set in e.g. a range from 0.05 N·m to 3 N·m. The preferable ranges of these force threshold values are applied to the other embodiments.

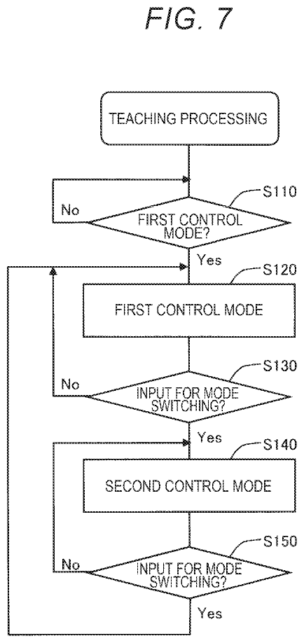

FIG. 7 is the flowchart of the teaching processing in the first embodiment. The teaching processing is executed by the control apparatus 200 and the teaching apparatus 300.

At step S110, the apparatuses wait until the control mode of the robot 100 is changed to the first control mode by the user. The input at step S110 may be performed using e.g. the switch with key 340 of the teaching apparatus 300. Or, the control mode may be changed to the first control mode by input with password to the touch panel 320. In the embodiment, the first control mode is the direct teaching mode. When the control mode is changed to the first control mode, the processing moves to step S120. At step S120, the arm control unit 212 executes control of the arm by the first control mode. At step S130, the control mode selection unit 214 determines whether or not input for mode switching has been performed. In the first embodiment, the input for mode switching is an operation by the user tapping the end effector 130 according to the force change pattern FP described in FIG. 6. Note that the input for mode switching may be performed using the input unit of the control apparatus 200 or teaching apparatus 300.

If the input for mode switching is detected at step S130, the control mode is switched from the first control mode to the second control mode, and the processing moves to step S140. At step S140, the arm control unit 212 executes control of the arm by the second control mode. At step S150, the control mode selection unit 214 determines whether or not input for mode switching has been performed like the step S130. If the input for mode switching is performed, the processing returns to step S120 and the processing at step S120 and the subsequent steps is executed again. Note that the processing in FIG. 7 is executed until the teaching processing ends. An instruction to end the teaching processing may be given by the user using the teaching apparatus 300, for example.

As described above, in the first embodiment, when the direction of the force detected by the force detector 190 is the first direction D1, the first control mode in which the arm is moved in the first direction D1 and the second control mode in which the arm is moved in the second direction D2 different from the first direction D1 are available. Further, the first control mode or second control mode is selected according to the input by the user, and thereby, the relationship between the direction of the force and the movement direction of the arm may be easily changed.

### B. Second Embodiment

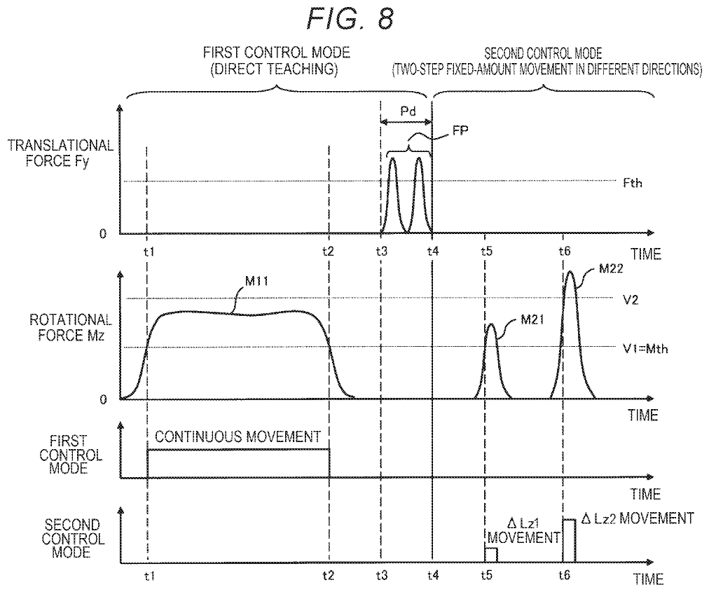

FIG. 8 is the graph showing the example of changes of forces detected by the force detector in the second embodiment. The second embodiment is different from the first embodiment only in the details of the second control mode, but the same in the apparatus configuration and the processing procedure as the first embodiment.

The operation from time t1 to time t4 in FIG. 8 is the same as that in FIG. 6. In FIG. 8, in the second control mode, a first value V1 equal to the force threshold value Mth shown in FIG. 6 and a second value V2 larger than the first value V1 are used. Of the two rotational forces M21, M22 detected in the second control mode, the peak of the first rotational force M21 is equal to or larger than the first value V1 (=Fth) and smaller than the second value V2, and the peak of the second rotational force M22 is equal to or larger than the second value V2. In this case, in the control executed according to the first rotational force M21, the end effector 130 moves in the Z-axis direction in a predetermined first amount of movement ΔLz1. Further, in the control executed according to the second rotational force M22, the end effector 130 moves in the Z-axis direction in a predetermined second amount of movement ΔLz2. The second amount of movement ΔLz2 is set to a larger value than the first amount of movement ΔLz1. For example, the first amount of movement ΔLz1 is set to 0.1 mm, and the second amount of movement ΔLz2 is set to 1 mm.

As described above, the plurality of threshold values V1, V2 with respect to the second control mode are set in advance and the movements are made in the different amounts of movement ΔLz1, ΔLz2 according to whether or not the peak of the force is equal to or larger than either of the threshold values, and thereby, the user can easily use the coarser fine adjustment and the finer fine adjustment properly.

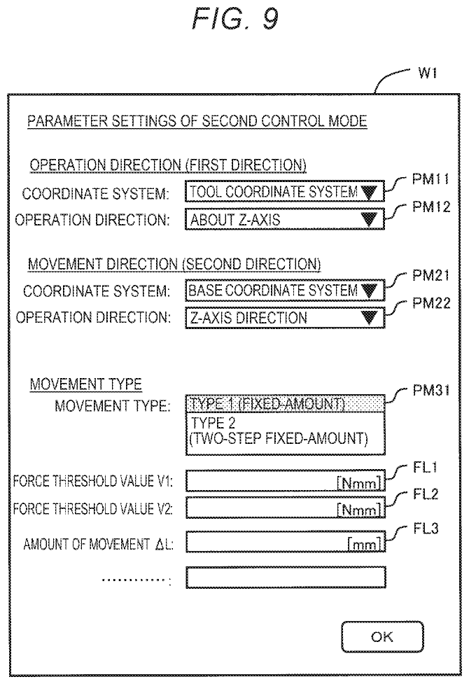

FIG. 9 is the explanatory diagram showing a window W1 for setting various parameters of the second control mode in the second embodiment. The window W1 is an input window displayed on the display 250 of the control apparatus 200. Here, an operation direction, a movement direction, and various parameters relating to a movement type can be set. The parameters set in the window W1 are received by the input receiving unit 216 of the control apparatus 200.

“Operation direction” refers to a direction in which a force is applied to the arm in the second control mode and corresponds to “first direction”. “Movement direction” refers to a direction in which the arm moves in the second control mode and corresponds to “second direction”. In the above described example of FIG. 5, the operation direction is the rotation direction D1 about the Z-axis and the movement direction is the direction D2 parallel to the Z-axis.

In the window W1, regarding the operation direction, a pull-down menu PM11 for selection of a coordinate system and a pull-down menu PM12 for selection of an operation direction in the coordinate system are provided. In the example of FIG. 9, the direction about the Z-axis in the tool coordinate system is selected as the operation direction. In the window W1, further, regarding the movement direction, a pull-down menu PM21 for selection of a coordinate system and a pull-down menu PM22 for selection of a movement direction in the coordinate system are provided. In the example of FIG. 9, the Z-axis direction in the base coordinate system is selected as the movement direction.

For the operation direction and the movement direction, arbitrary coordinate systems relating to the robot system are selectable and arbitrary directions in the six-axis directions in the selected coordinate systems are selectable. In the above described example of FIG. 5, the operation direction (first direction) is the direction about the Z-axis in the sensor coordinate system Σf and the movement direction (second direction) is the Z-axis direction in the sensor coordinate system Σf. The movement direction may be further selectable between the movement direction of the right-handed screw as described in FIG. 5 and a movement direction of a left-handed screw.

Note that a direction defined in the first coordinate system that moves according to the movement of the arm may be selected as the operation direction (first direction), and a direction defined in the second coordinate system that does not move according to the movement of the arm may be selected as movement direction (second direction). In this manner, in the second control mode, a force is applied in the first direction that changes with the movement of the arm, and thereby, the arm may be moved in the second direction that does not move even when the arm moves.

In FIG. 9, further, a pull-down menu PM31 for selection of a movement type, fields FL1, FL2 for input of force threshold values V1, V2, and a field for input of an amount of movement ΔL are provided.

As the movement type, for example, one of the following plurality of types is selectable.
<Type 1> Movement type of fixed-amount movement in different directions described in FIG. 6.
<Type 2> Movement type of two-step fixed-amount movement in different directions described in FIG. 8.
<Type 3> Movement type of setting a larger amount of movement as the force detected by the force detector 190 is larger.
<Type 4> Movement type of setting a higher velocity of movement as the force detected by the force detector 190 is larger.
<Type 5> Movement type of setting a larger amount of movement as duration in which the magnitude of the force detected by the force detector 190 is equal to or larger than the force threshold value is longer.
<Type 6> Movement type of setting a larger amount of movement as an operation distance or operation angle in the operation direction is larger.

According to the movement types of types 3 to 6, the amount of movement and the velocity of movement may be adjusted according to the force and the amount of operation applied to the arm by the user, and thereby, fine adjustment of position and posture according to the preference of the user can be made.

Of the plurality of parameters including the force threshold values V1, V2 and the amount of movement ΔL, only the parameters used in the selected movement type are subjects to be input by the user. For example, when the type 1 is selected as the movement type, only the two parameters of the force threshold value V1 and the amount of movement ΔL are subjects to be input by the user.

As described above, in the second embodiment, the input receiving unit 216 receives the settings of the first direction and the second direction from the user, and thus, the relationship between the first direction and the second direction in the second control mode may be changed according to the preference of the user. Further, as the movement type in the second control mode, one of the plurality of types prepared in advance may be selected, and fine adjustment may be easily performed as appropriate.

### C. Third Embodiment

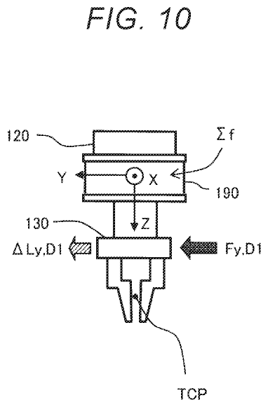

FIG. 10 is the explanatory diagram showing the relationship between the force and the amount of movement in the first control mode of the third embodiment. In the first control mode, when the user applies a translational force Fy to the end effector 130 along the first direction D1 as the Y-axis direction, the arm moves in the first direction D1 in a predetermined amount of movement ΔLy according to the application. The amount of movement ΔLy is set to a small value e.g. from 0.1 mm to 1 mm. The same applies to the cases where the user applies a translational force in the X-axis direction and applies a translational force in the Z-axis direction. Therefore, in the first control mode, fine adjustment of the positions of the end effector 130 and the TCP can be made. The movement by the first control mode also corresponds to “fixed-amount movement”. Note that, as the first control mode, the two-step fixed-amount movement described in the second control mode in FIG. 8 may be executed. Also, in this case, in the first control mode, the operation direction and the movement direction are the same direction.

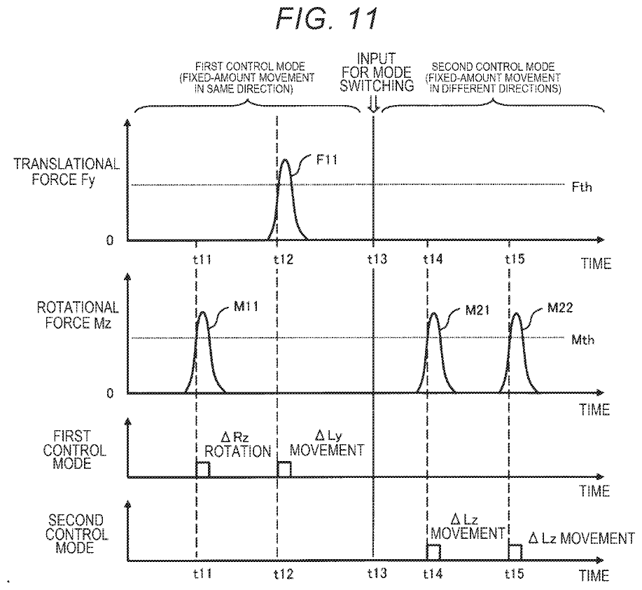

FIG. 11 is the graph showing the example of changes of forces detected by the force detector in the third embodiment. The third embodiment is different from the first embodiment only in the details of the first control mode, but the same in the apparatus configuration and the processing procedure as the first embodiment.

The first control mode is set in a period until time t13, and the mode is switched from the first control mode to the second control mode at time t13. The details of the second control mode after time t13 are the same as the details of the second control mode after time t4 in FIG. 6, and the end effector 130 moves in the amounts of movement ΔLz at times t14 and t15. The input for mode switching at time t13 may be performed using the input unit of the control apparatus 200 or teaching apparatus 300.

At time t11, a rotational force M11 equal to or larger than a force threshold value Mth is detected. When the rotational force M11 is detected, the end effector 130 moves along the direction of the rotational force M11 in a predetermined amount of movement ΔRz. The amount of movement ΔRz is a rotation angle about the Z-axis. At time t12, a translational force F11 equal to or larger than a force threshold value Fth is detected. When the translational force F11 is detected, the end effector 130 moves along the direction of the translational force F11 in a predetermined amount of movement ΔLy.

As described above, as the first control mode, other kinds of control modes than direct teaching are available. Also, in this case, like the above described other embodiments, the first control mode or second control mode is selected according to the input by the user, and thereby, the relationship between the direction of the force and the movement direction of the arm may be easily changed.

### D. Other Embodiments

The present disclosure is not limited to the above described embodiments, but may be realized in various aspects without departing from the scope thereof. For example, the present disclosure can be realized in the following aspects. The technical features in the above described embodiments corresponding to technical features in the following respective aspects can be appropriately replaced or combined for solving part or all of the problems of the present disclosure or achieving part or all of the effects of the present disclosure. Further, the technical features can be appropriately deleted unless the technical features are described as essential features in this specification.

(1) According to a first aspect of the present disclosure, a control apparatus that controls a robot including an arm and a force detector detecting a force applied to the arm is provided. The control apparatus includes a control unit that controls the arm in a first control mode in which the arm is moved in a first direction when a direction of a force detected by the force detector is the first direction and a second control mode in which the arm is moved in a second direction different from the first direction when the direction of the force detected by the force detector is the first direction in teaching of the robot. The control unit selects the first control mode or the second control mode according to input by a user.

According to the control apparatus, the first control mode or the second control mode is selected according to the input by the user, and thereby, a relationship between the direction of the force and the movement direction of the arm may be easily changed.

(2) In the control apparatus, the arm may have a pivot part that pivots about a pivot axis, the first direction may be a pivot direction in which the pivot part is pivoted about the pivot axis, and the second direction may be an axial direction of the pivot axis.

According to the control apparatus, in the second control mode, the pivot part is pivoted, and thereby, the arm may be moved in a direction parallel to the pivot axis.

(3) In the control apparatus, the control unit may switch between the first control mode and the second control mode when a change pattern of the force applied to the arm by the user as the input by the user matches a predetermined reference pattern.

According to the control apparatus, the relationship between the direction of the force and the movement direction of the arm may be easily switched according to the change pattern of the force applied to the arm by the user.

(4) In the control apparatus, the first control mode may be a mode in which the arm is continuously moved according to the force detected by the force detector, and the second control mode may be a mode in which the arm is moved in a predetermined amount of movement according to the force detected by the force detector.

According to the control apparatus, the first control mode in which the arm is continuously moved and the second control mode in which the arm is moved in the fixed amount of movement may be easily switched.

(5) In the control apparatus, the first control mode and the second control mode may be respectively modes of moving the arm in predetermined amounts of movement according to the force detected by the force detector.

According to the control apparatus, the relationship between the direction of the force and the movement direction of the arm may be easily changed by switching between the first control mode and the second control mode in which the arm is moved in the fixed amounts of movement.

(6) In the control apparatus, in the second control mode, the amount of movement may be larger as the force detected by the force detector is larger.

According to the control apparatus, in the second control mode, the arm may be moved in the larger amount of movement as the force applied to the arm is larger.

(7) In the control apparatus, in the second control mode, a velocity of movement of the arm may be higher as the force detected by the force detector is larger.

According to the control apparatus, in the second control mode, the arm may be moved in the higher velocity of movement as the force applied to the arm is larger.

(8) In the control apparatus, in the second control mode, the amount of movement may be larger as duration in which magnitude of the force detected by the force detector is equal to or larger than a force threshold value is longer.

According to the control apparatus, in the second control mode, the arm may be moved in the larger amount of movement as the duration of the force equal to or larger than the force threshold value is longer.

(9) In the control apparatus, the first direction may be a direction defined in a first coordinate system, and the second direction may be a direction defined in a second coordinate system.

According to the control apparatus, in the second control mode, a force is applied in the first direction defined in the first coordinate system, and thereby, the arm may be moved in the second direction defined in the second coordinate system.

(10) In the control apparatus, the first coordinate system may move according to the movement of the arm and the second coordinate system may not move according to the movement of the arm.

According to the control apparatus, in the second control mode, a force is applied in the first direction that changes with the movement of the arm, and thereby, the arm may be moved in the second direction that does not move even when the arm moves.

(11) The control apparatus may further include an input receiving unit that receives settings of the first direction and the second direction from the user.

According to the control apparatus, the relationship between the first direction and the second direction in the second control mode may be changed according to the preference of the user.

(12) The control apparatus may further include a display control unit that allows a display to display whether the first control mode or the second control mode is selected.

According to the control apparatus, the user may easily know that the control mode is the first control mode or the second control mode.

(13) According to a second aspect of the present disclosure, a robot system including a robot including an arm and a force detector detecting a force applied to the arm, and the control apparatus according to any one of the above described embodiments is provided.

According to the robot system, the first control mode or the second control mode is selected according to the input by the user, and thereby, the relationship between the direction of the force and the movement direction of the arm may be easily changed.

The present disclosure can be realized in various other aspects than the above described aspects, e.g. a robot system including a robot and a robot control apparatus, a computer program for realizing functions of a robot control apparatus, a non-transitory storage medium in which the computer program is recorded, or the like.

What is claimed is:

1. A control apparatus comprising:
a processor that is configured to execute computer-executable instructions so as to control a robot including an arm and a force detector detecting a force applied to the arm,
wherein the processor is configured to:
control the arm in a first control mode in which the arm is moved in a first direction when a direction of a force detected by the force detector is the first direction and a second control mode in which the arm is moved in a second direction different from the first direction when the direction of the force detected by the force detector is the first direction in teaching of the robot, and
select the first control mode or the second control mode according to input by a user.

2. The control apparatus according to claim 1, wherein
the arm has a pivot part that pivots about a pivot axis,
the first direction is a pivot direction in which the pivot part is pivoted about the pivot axis, and
the second direction is an axial direction of the pivot axis.

3. The control apparatus according to claim 1, wherein
the processor is configured to switch between the first control mode and the second control mode when a change pattern of the force applied to the arm by the user as the input by the user matches a predetermined reference pattern.

4. The control apparatus according to claim 1, wherein
the first control mode is a mode in which the arm is continuously moved according to the force detected by the force detector, and
the second control mode is a mode in which the arm is moved in a predetermined amount of movement according to the force detected by the force detector.

5. The control apparatus according to claim 1, wherein
the first control mode and the second control mode are respectively modes of moving the arm in predetermined amounts of movement according to the force detected by the force detector.

6. The control apparatus according to claim 1, wherein,
in the second control mode, the amount of movement is larger as the force detected by the force detector is larger.

7. The control apparatus according to claim 1, wherein,
in the second control mode, a velocity of movement of the arm is higher as the force detected by the force detector is larger.

8. The control apparatus according to claim 1, wherein,
in the second control mode, the amount of movement is larger as duration in which magnitude of the force detected by the force detector is equal to or larger than a force threshold value is longer.

9. The control apparatus according to claim 1, wherein
the first direction is a direction defined in a first coordinate system, and
the second direction is a direction defined in a second coordinate system.

10. The control apparatus according to claim 9, wherein
the first coordinate system moves according to the movement of the arm, and
the second coordinate system does not move according to the movement of the arm.

11. The control apparatus according to claim 1, wherein
the processor is configured to receive settings of the first direction and the second direction from the user.

12. The control apparatus according to claim 1, wherein
the processor is configured to allow a display to display whether the first control mode or the second control mode is selected.

13. A robot system comprising:
a robot including an arm and a force detector detecting a force applied to the arm; and
a control device that comprises a processor that is configured to execute computer-executable instructions so as to control the robot;
wherein the processor is configured to:
control the arm in a first control mode in which the arm is moved in a first direction when a direction of a force detected by the force detector is the first direction and a second control mode in which the arm is moved in a second direction different from the first direction when the direction of the force detected by the force detector is the first direction in teaching of the robot, and
select the first control mode or the second control mode according to input by a user.

14. The robot system according to claim 13, wherein
the arm has a pivot part that pivots about a pivot axis,
the first direction is a pivot direction in which the pivot part is pivoted about the pivot axis, and
the second direction is an axial direction of the pivot axis.

15. The robot system according to claim 13, wherein
the processor is configured to switch between the first control mode and the second control mode when a change pattern of the force applied to the arm by the user as the input by the user matches a predetermined reference pattern.

16. The robot system according to claim 13, wherein
the first control mode is a mode in which the arm is continuously moved according to the force detected by the force detector, and
the second control mode is a mode in which the arm is moved in a predetermined amount of movement according to the force detected by the force detector.

17. The robot system according to claim 13, wherein
the first control mode and the second control mode are respectively modes of moving the arm in predetermined amounts of movement according to the force detected by the force detector.

18. The robot system according to claim 13, wherein,
in the second control mode, the amount of movement is larger as the force detected by the force detector is larger.

19. The robot system according to claim 13, wherein,
in the second control mode, a velocity of movement of the arm is higher as the force detected by the force detector is larger.

20. The robot system according to claim 13, wherein,
in the second control mode, the amount of movement is larger as duration in which magnitude of the force detected by the force detector is equal to or larger than a force threshold value is longer.
